(19) United States
(12) Patent Application Publication
(10) Pub. No.: US 2009/0225244 A1
(43) Pub. Date: Sep. 10, 2009

(54) IMAGE DISPLAY DEVICE AND LIGHT SOURCE CONTROL DEVICE THEREFOR

(76) Inventors: Wen-Chun Wang, Taichung County (TW); Chun-Chia Liu, Taichung City (TW)

Correspondence Address: Muncy, Geissler, Olds & Lowe, PLLC, P.O. BOX 1364, FAIRFAX, VA, 22038-1364, US

(21) Appl. No.: 12/399,746

(22) Filed: Mar. 6, 2009

Related U.S. Application Data
(60) Provisional application No. 61/034,729, filed on Mar. 7, 2008.

(51) Int. Cl. G02F 1/137

(52) U.S. Cl. 349/15; 349/35

(57) ABSTRACT

An image display device comprises a display panel, a backlight module, a light path modifying device, and a switchable diffuser. The backlight module is to emit light as the display light source of the display panel. The light path modifying device is disposed between the display panel and the backlight module for changing the light path of the light to generate the first display mode in coordination with the display panel. The switchable diffuser is disposed between the light path modifying device and the display panel, and is capable of switching between a transparent mode and a scattering mode. The display device displays the first display mode in the transparent mode and displays the second display mode in the scattering mode.

### CROSS REFERENCE TO RELATED APPLICATION

This application claims benefit of U.S. provisional application No. 61/034,729 filed on Mar. 7, 2008 under 35 U.S.C. §119(e); the entire contents of which are hereby incorporated by reference.

### BACKGROUND OF THE INVENTION

1. Field of the Invention

The present invention relates to an image display device, and more particularly, to an image display device having the function of switching among various display modes.

2. Description of the Related Art

FIG. 1 shows a schematic diagram illustrating an image display device 100 in the prior art that utilizes the parallax optical component to generate three dimensional image automatically. The image display device 100 as shown in FIG. 1 comprises a liquid crystal panel 102, a parallax barrier plate 104, and a backlight module 116. The parallax barrier plate 104 includes a glass substrate 118 and a plurality of stripe-type light shading portions 120 formed on the glass substrate 118 and is in contact with the surface of the liquid crystal panel 102 to work as the light separating device for separating the images for the left eye and the right eye. A liquid crystal layer 110 is sandwiched between the glass substrates 106 and 108 of the liquid crystal panel 102. A polarizer 112 is disposed on the glass substrate 106 of the observer 122's side (the light exit side) while a polarizer 114 is disposed on the side of the backlight module 116 (the light incident side). According to the method in the prior art as shown in FIG. 1, the three-dimensional image is generated by displaying the image for the left eye and the image for the right eye alternately disposed in the liquid crystal layer. The light emitted from the backlight module 116 passes through the image for the left eye and the image for the right eye and is mutually separated by the parallax barrier plate 104. Parallax effect is generated when the left eye of the observer 122 only observes the image for the left eye while the right eye only observes the image for the right eye and, thereby, the observer 122 automatically senses a three-dimensional image. Such a design can only allow the display device 100 to display a three-dimensional (3D) image but cannot switch between a two-dimensional (2D) display mode and a three-dimensional (3D) display mode.

On the other hand, although a light collimating device disposed between the backlight module 116 and the liquid crystal panel 102 prohibits the light at a large viewing angle from passing through to show the narrow viewing angle effect, it cannot make the image display device 100 switch between the narrow viewing angle mode and the wide viewing angle mode. A structure that controls turning the liquid crystal molecule must be provided in the liquid crystal layer of the liquid crystal panel 102 to control the viewing angle and the manufacturing process for such a structure is very complicated.

### BRIEF SUMMARY OF THE INVENTION

One embodiment of the invention provides an image display device having the function of switching among various display modes and the light source control device thereof. The display brightness variation between two display modes is smaller when the image display device switches from a first display mode to a second display mode. One embodiment of the invention provides an image display device having the function of switching between the two-dimensional (2D) and three-dimensional (3D) display modes or between the narrow viewing angle and wide viewing angle display modes and the light source control device thereof.

One embodiment of the invention provides an image display device, suitable for showing a first display mode and a second display mode that is different from the first display mode. The image display device comprises a display panel, a backlight module, a light path modifying device, and a switchable diffuser. The backlight module is disposed facing the display panel for emitting light as the display light source of the display panel. The light path modifying device is disposed between the display panel and the backlight module for changing the light path of the light to generate the first display mode in coordination with the display panel. The switchable diffuser is disposed between the light path modifying device and the display panel, and is capable of switching between a transparent mode and a scattering mode. The switchable diffuser receiving a first voltage does not scatter the light in the transparent mode, and the switchable diffuser receiving a second voltage scatters the light in the scattering mode. The display device displays the first display mode in the transparent mode and displays the second display mode in the scattering mode.

One embodiment of the invention provides a backlight module for optionally showing a first brightness mode or a second brightness mode on the basis of whether the switchable diffuser shows the transparent mode or the scattering mode. More specifically, the switchable diffuser shows the transparent mode when receiving a first voltage and shows the scattering mode when receiving the second voltage. Preferably, the backlight module receives a third voltage when the switchable diffuser receives the first voltage and the backlight module receives a fourth voltage when the switchable diffuser receives the second voltage. In one embodiment, the image display device further comprises a first power controller and a second power controller. The first power controller optionally provides the first voltage or the second voltage and the second power controller optionally provides the third voltage or the fourth voltage.

The image display device according to one embodiment of the invention further comprises a light sensor. The light sensor is to sense the light passing through the switchable diffuser and performs a brightness measurement. The backlight module shows different brightness modes according to the brightness measurement. Preferably, the image display device further comprises a power controller. The power controller provides different voltages to the backlight module according to the brightness measurement.

The light path modifying device according to one embodiment of the invention is a parallax optical component. The parallax optical component shows the visual separating effect and the first display mode is the three-dimensional (3D) display mode while the second display mode is the two-dimensional (2D) display mode.

The light path modifying device according to one embodiment of the invention is a light collimating device. The light collimating device collimates the light emitted from the backlight module and the first display mode shows the narrow viewing angle mode while the second display mode shows the wide viewing angle mode.

According to the design of the above-mentioned various embodiments, one embodiment of the invention can provide an image display device having the function of switching among various display modes.

Another embodiment of the invention provides a light source control device disposed between a display panel and a light source provided for the display panel. The light source control device is turned on to be in a first mode and is turned off to be in a second mode. In the first mode, the light being already collimated or separated passes through without changing the original propagation route. In the second mode, the light being already collimated or separated is scattered and changes the original propagation route. The first mode corresponds to a three-dimensional (3D) display mode or a narrow viewing angle display mode while the second mode corresponds to a two-dimensional (2D) display mode or a wide viewing angle mode. According to the design of the above-mentioned embodiments, a switchable diffuser, disposed between the display panel and the light source provided for the display panel, functions as the light source control device which is turned on to be in a first mode and is turned off to be in a second mode. In the first mode, the light being already collimated or separated passes through without changing the original propagation route, while, in the second mode, the light being already collimated or separated is scattered and changes the original propagation route. The light source control device can enable an image display device to switch between the two-dimensional (2D) display mode and the three-dimensional (3D) display mode for providing different visual effect. In addition, the light source control device may enable an image display device to switch between the narrow viewing angle display mode and the wide viewing angle display mode for displaying the information publicly or privately.

Other purposes and benefits of the invention can be further understood by the technical features disclosed in the above-mentioned embodiments. In order to provide better and more obvious understanding of the purposes, features, and benefits of the invention, the detailed descriptions of the embodiments according to the invention will be given in the following together with figures.

### BRIEF DESCRIPTION OF THE DRAWINGS

FIG. 1 shows a schematic diagram illustrating a traditional image display device that utilizing a parallax optical component to generate three dimensional image automatically;

FIGS. 2A and 2B show schematic diagrams illustrating the image display device according to one embodiment of the invention where FIG. 2A shows a two-dimensional (2D) display mode and FIG. 2B shows a three-dimensional (3D) display mode;

FIGS. 3A and 3B show schematic diagrams illustrating another embodiment of the invention to describe the effect of the parallax barrier plate having opaque blocks that are made of reflective material;

FIGS. 4 and 5 show schematic diagrams illustrating different parallax optical components according to other embodiments of the invention;

FIGS. 6A and 6B show schematic diagrams illustrating the image display device according to another embodiment of the invention where FIG. 6A shows a wide viewing angle display mode and FIG. 6B shows a narrow viewing angle display mode;

FIGS. 7-11 show schematic diagrams illustrating different light collimating devices according to other embodiments of the invention;

FIGS. 12A and 12B show schematic diagrams illustrating another embodiment of the invention to describe the effect of the light collimating device having opaque blocks that are made of reflective material; and

FIG. 13 shows a schematic diagram illustrating the image display device according to another embodiment of the invention.

FIGS. 14A and 14B respectively show a schematic diagram illustrating the image display device according to another embodiment of the invention.

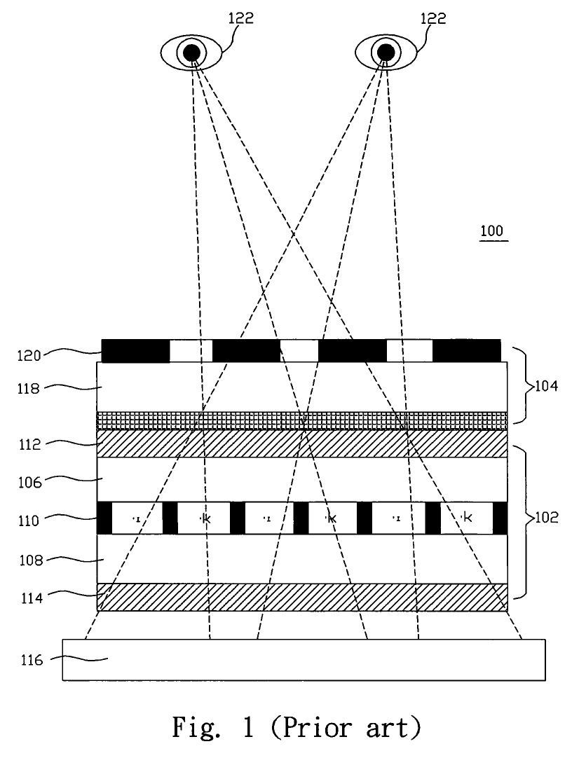

### DETAILED DESCRIPTION OF THE INVENTION

The above mentioned and other technical contents, uniqueness, and effects of the invention can be illustrated more clearly by the following detailed descriptions together with the corresponding figures. The wording describing directions used in the following descriptions, such as: up, down, left, right, front, back or the like, indicates the directions with respect to the figure only. Therefore, the wording used to describe directions is for illustration but not to limit the scope of the invention.

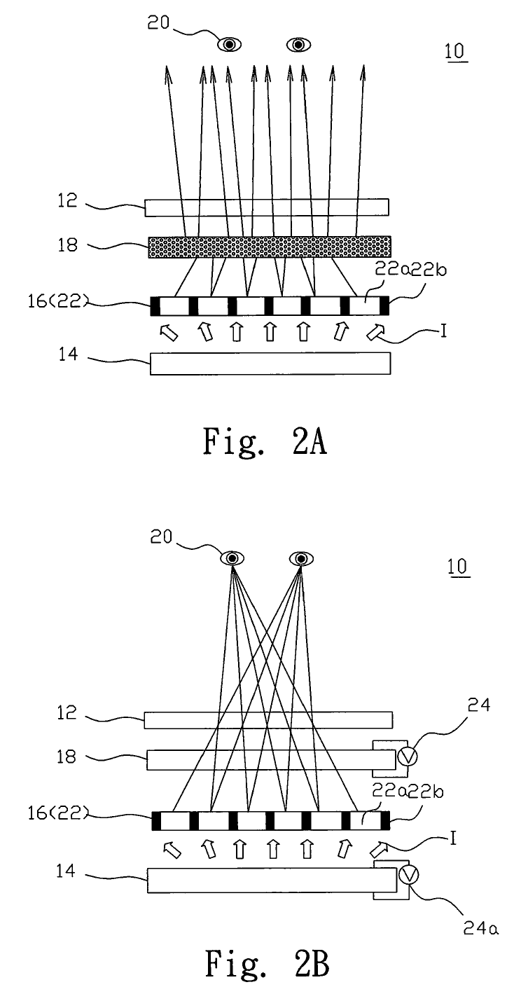

FIGS. 2A and 2B show schematic diagrams illustrating the image display device 10 according to one embodiment of the invention where FIG. 2A shows a two-dimensional (2D) display mode and FIG. 2B shows a three-dimensional (3D) display mode. As shown in FIGS. 2A and 2B, the image display device 10 can switch between 2D and 3D display modes. The image display device 10 comprises a display panel 12, a backlight module 14, a parallax optical component 16, and a switchable diffuser 18. The backlight module 14 is disposed facing the display panel 12 for emitting light I as the display light source of the display panel. The parallax optical component 16 is disposed between the display panel 12 and the backlight module 14 for generating the visual separating effect. In this embodiment, the parallax optical component 16 is a parallax barrier plate 22. The parallax barrier plate 22 comprises a plurality of alternately disposed transparent blocks 22a and opaque blocks 22b. The light I emitted from the backlight module 14 is mutually separated into two portions respectively passing through the image for the left eye and the image for the right eye by the parallax barrier plate 22. As a result, the parallax effect is generated such that the left eye of the observer 20 only observes the image for the left eye and the right eye of the observer 20 only observes the image for the right eye. Thus, the observer 20 automatically senses a 3D image. The switchable diffuser 18 is disposed between the parallax barrier plate 22 and the display panel 12. In this embodiment, the switchable diffuser 18 being turned on (ON) shows transparent when a voltage is applied thereto; the switchable diffuser 18 being turned off (OFF) shows haze when no voltage is applied thereto. In another embodiment, the switchable diffuser 18 being turned off (OFF) may show transparent when no voltage is applied thereto; the switchable diffuser 18 being turned on (ON) may show haze when a voltage is applied to thereto. Therefore, when the switchable diffuser 18 is turned off as shown in FIG. 2A, the light mutually separated by the parallax barrier plate 22 is scattered by the hazed switchable diffuser 18 and, thereby, the light entering the observer 20 does not shows the visual separating effect so that the image display device 10 displays two-dimensional (2D) images. On the other hand, when the switchable diffuser 18 is turned on as shown in FIG. 2B, the light mutually separated by the parallax barrier plate 22 can pass through the transparent switchable diffuser 18 along the original light path without any influence and, thereby, the light entering the observer 20 shows the visual separating effect so that the image display device 10 displays three-dimensional (3D) images.

In one embodiment, the image display device 10 further comprises a first voltage controller 24. The first voltage controller 24 is coupled to the switchable diffuser 18 for optionally providing a first voltage or a second voltage to the switchable diffuser 18. The switchable diffuser 18 shows the transparent mode when receiving the first voltage and shows the haze mode when receiving the second voltage. Preferably, the second voltage is zero so that the switchable diffuser 18 is turned on when receiving the first voltage and is turned off when receiving the second voltage at zero, that is, turned off when not receiving any voltage.

The display brightness of the normal direction of the image display device 10 reduces when the switchable diffuser 18 switches from the transparent mode to the haze mode. The human eyes detect the brightness change instantly, and the display quality is affected due to decrease in the display brightness after switching. In one embodiment, the backlight module 14 optionally shows a first brightness mode or a second brightness mode according to whether the switchable diffuser 18 shows the transparent mode or the haze mode. Preferably, the brightness of the second brightness mode is higher than that of the first brightness mode. Therefore, when the switchable diffuser 18 switches to the haze mode from the transparent mode, the backlight module 14 also switches from the first brightness mode to the second brightness mode. Not only the display brightness variation of the image display device 10 sensed by the human eyes is reduced, but the light intensity loss induced by the haze mode of the switchable diffuser 18 is also compensated. As a result, the display brightness of the normal direction is compensated and the display quality is improved. On the other hand, the backlight module 14 also switches to the first brightness mode from the second brightness mode when the switchable diffuser 18 switches from the haze mode to the transparent mode. The display brightness variation of the image display device 10 sensed by the human eyes can also be reduced and the display quality is improved.

In one embodiment, the image display device 10 can further comprise a second voltage controller 24a being coupled to the backlight module 14. When the switchable diffuser 18 receives the first voltage, the second voltage controller 24a provides a third voltage to the backlight module 14 for showing the first brightness mode. When the switchable diffuser 18 receives the second voltage, the second voltage controller 24a provides a fourth voltage to the backlight module 14 for showing the second brightness mode. Preferably, the fourth voltage is higher than the third voltage.

In one embodiment, the switchable diffuser 18 can be a polymer dispersed liquid crystal (PDLC) panel or a bi-stable cholesteric liquid crystal panel.

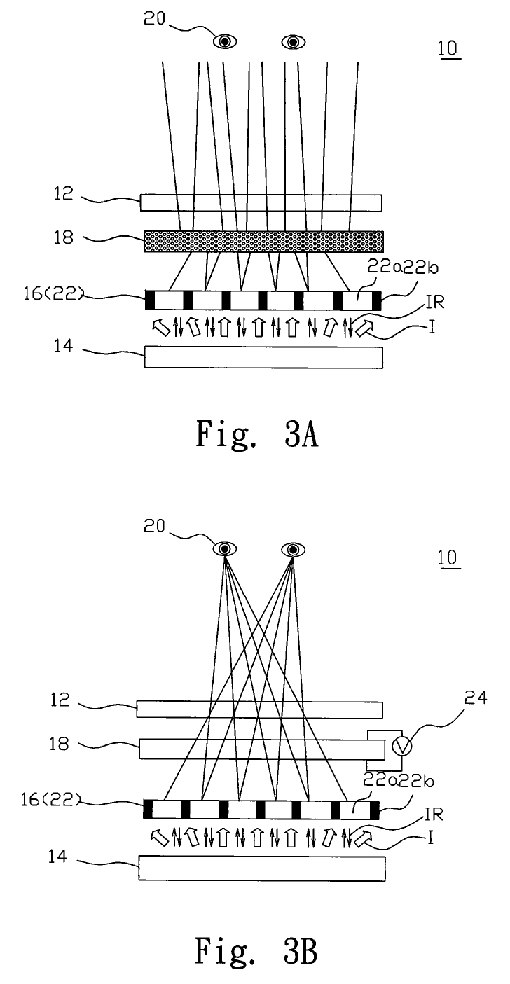

FIGS. 3A and 3B show schematic diagrams illustrating another embodiment of the invention. Referring to FIGS. 3A and 3B, the effect provided by the parallax barrier plate having opaque blocks that are made of reflective material will be described. The material for the opaque block 22b of the parallax barrier plate 22 is not limited and can be made by, for example, metallic material, plastic material, or ink material. Please refer to the FIGS. 3A and 3B. When the opaque block 22b of the parallax barrier plate 22 is formed by utilizing the reflective material such as metallic material, the light IR shaded by the opaque block 22b can be reflected back into the backlight module 14 and, then, reflected by the backlight module 14 again towards the direction of the parallax barrier plate 22 for emitting. The light that may be absorbed originally can be recycled and utilized to increase the light emitting efficiency.

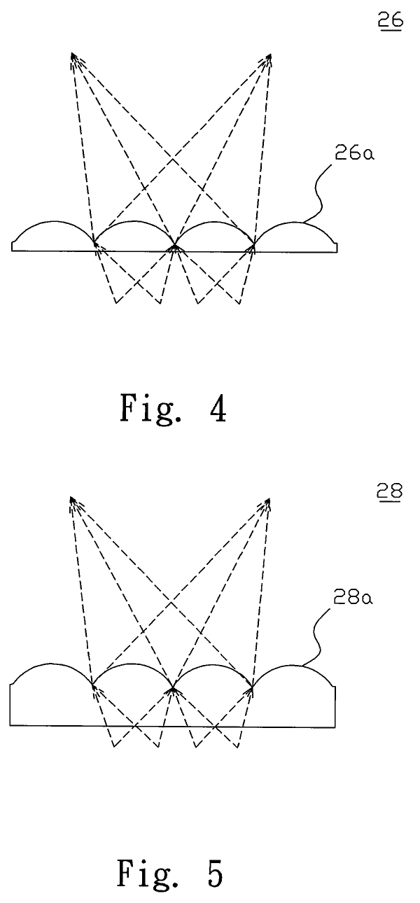

Furthermore, the parallax optical component according to the invention providing parallax effect is not limited to the parallax barrier plate 22. A single focusing lens set 26 (FIG. 4) or a single cylindrical lens set 28 (FIG. 5) can also be used. The single focusing lens set 26 comprises a plurality of focusing lens structures 26a and the single cylindrical lens set 28 comprises a plurality of cylindrical lens structures 28a. Obviously, the focusing lens structure 26a and the cylindrical lens structure 28a can also be mixed to form one single parallax optical component 16. The focusing lens structure 26a or the cylindrical lens structure 28a can be arranged on the top surface or the bottom surface of the same parallax optical component 16, or they may be formed on the top surface and the bottom surface of the same parallax optical component 16 together.

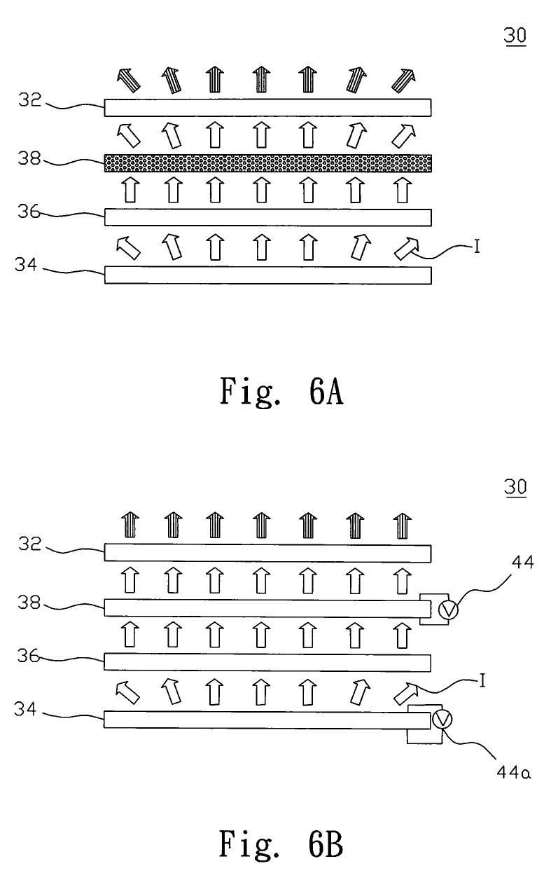

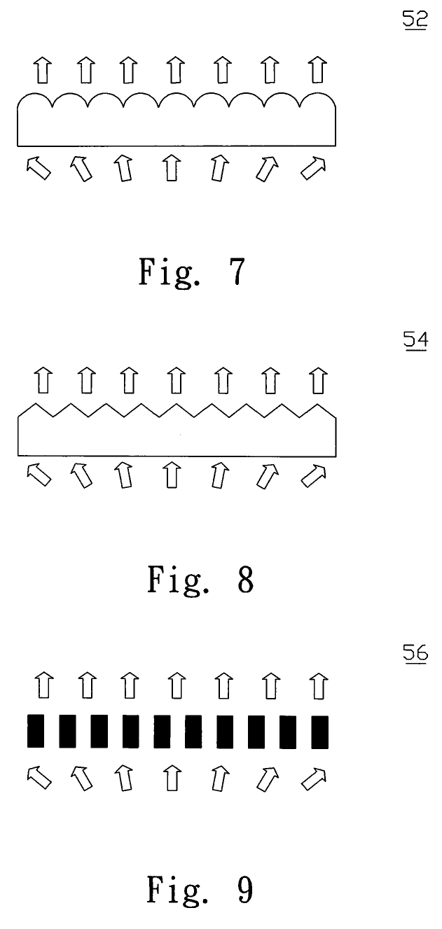

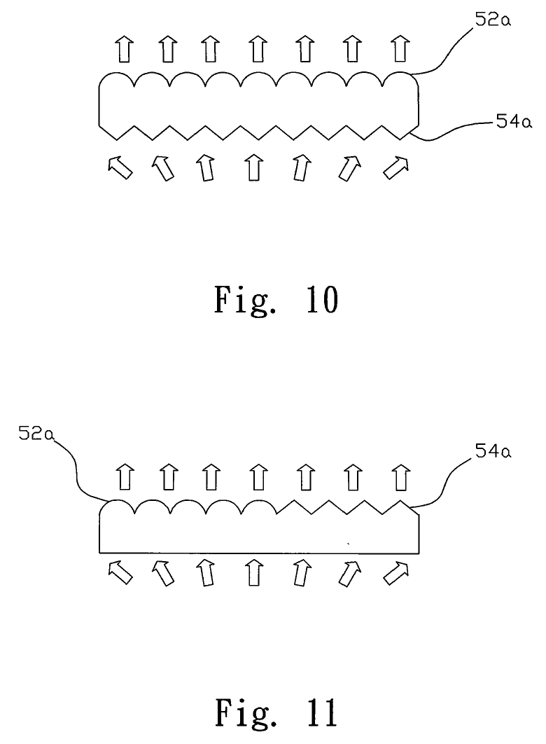

FIGS. 6A and 6B show schematic diagrams illustrating the image display device 30 according to another embodiment of the invention where FIG. 6A shows a wide viewing angle display mode and FIG. 6B shows a narrow viewing angle display mode. The image display device 30 can be switched between the wide viewing angle and the narrow viewing angle display modes. Please refer to FIG. 6A and FIG. 6B. The image display device 30 comprises a display panel 32, a backlight module 34, a light collimating device 36, and a switchable diffuser 38. The backlight module 34 is disposed facing the display panel 32 for emitting light I as the display light source of the display panel 32. The light collimating device 36, disposed between the display panel 32 and the backlight module 34, collimates the light I. The light collimating device 36 can be, for example, a single cylindrical lens set 52 (FIG. 7), a single cylindrical prism set 54 (FIG. 8), a parallax barrier plate 56 (FIG. 9) or the like. Or, the cylindrical lens structure 52a and the cylindrical prism structure 54a can be mixed to form one single light collimating device 36 (FIG. 10, FIG. 11). The cylindrical lens structure 52a and the cylindrical prism structure 54a may be arranged on the top surface or the bottom surface of the same light collimating device 36, or they may be formed on the top surface and the bottom surface of the same light collimating device 36 together (FIG. 10). The switchable diffuser 38 is disposed between the light collimating device 36 and the display panel 32. In this embodiment, the switchable diffuser 38 being turned on shows transparent when a voltage is applied thereto; the switchable diffuser 38 being turned off shows haze when no voltage is applied thereto. In another embodiment, the switchable diffuser 38 being turned off may show transparent when no voltage is applied thereto; the switchable diffuser being turned on 38 may show haze when a voltage is applied thereto. Therefore, after the light emitted by the backlight module 34 is collimated by the light collimating device 36 as shown in FIG. 6A, the light at a large viewing angle cannot pass through the light collimating device 36 and thus the image display device 30 shows the narrow viewing angle effect. However, when the switchable diffuser 38 is turned off, the light is scattered by the hazed switchable diffuser 38 to increase the viewing angle and thereby the image display device 30 shows the wide viewing angle display mode. On the other hand, after the light emitted by the backlight module 34 is collimated by the light collimating device 36 as shown in FIG. 6B, the light at a large viewing angle cannot pass through the light collimating device 36 and thus the image display device 30 shows the narrow viewing angle effect. But, when the switchable diffuser 38 is turned on, the light at a narrow viewing angle can pass through the transparent switchable diffuser 38 along the original light path without any influence and thereby the image display device 30 shows the narrow viewing angle display mode.

In one embodiment, the image display device 30 further comprises a first voltage controller 44. The first voltage controller 44 is coupled to the switchable diffuser 38 for optionally providing a first voltage or a second voltage to the switchable diffuser 38. The switchable diffuser 38 shows the transparent mode when receiving the first voltage and shows the haze mode when receiving the second voltage. Preferably, the second voltage is zero so that the switchable diffuser 38 is turned on when receiving the first voltage and turned off when receiving the second voltage at zero, that is, turned off when not receiving any voltage.

The display brightness of the normal direction of the image display device 30 reduces when the switchable diffuser 38 switches from the transparent mode to the haze mode. The human eyes detect the brightness change instantly and the display quality is affected due to decrease of the display brightness after switching. In one embodiment, the backlight module 34 optionally shows a first brightness mode or a second brightness mode on the basis of whether the switchable diffuser 38 shows the transparent mode or the haze mode. Preferably, the brightness of the second brightness mode is higher than that of the first brightness mode. Therefore, when the switchable diffuser 38 switches to the haze mode from the transparent mode, the backlight module 34 also switches from the first brightness mode to the second brightness mode. Not only the display brightness variation of the image display device 30 sensed by the human eyes is reduced, but the light intensity loss induced by the haze mode of the switchable diffuser 38 is also compensated. As a result, the display brightness of the normal direction is compensated and the display quality is improved. On the other hand, the backlight module 34 also switches to the first brightness mode from the second brightness mode when the switchable diffuser 38 switches from the haze mode to the transparent mode. The display brightness variation of the image display device 30 sensed by the human eyes can also be reduced and the display quality is improved.

In one embodiment, the image display device 30 further comprises a second voltage controller 44a that couples to the backlight module 34. When the switchable diffuser 38 receives the first voltage, the second voltage controller 44a provides a third voltage to the backlight module 34 for showing the first brightness mode. When the switchable diffuser 38 receives the second voltage, the second voltage controller 44a provides a fourth voltage to the backlight module 34 for showing the second brightness mode. Preferably, the fourth voltage is higher than the third voltage.

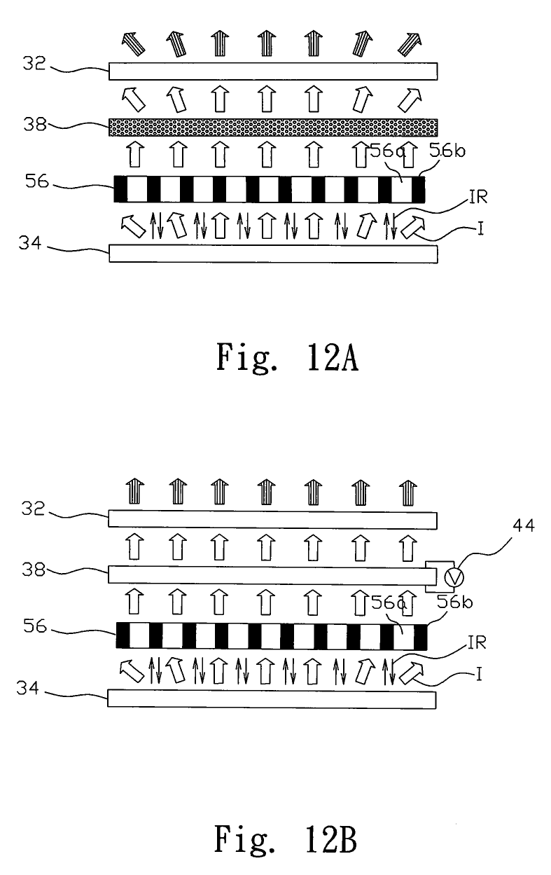

FIGS. 12A and 12B show schematic diagrams illustrating another embodiment of the invention. Referring to FIGS. 12A and 12B, the effect provided by the light collimating device having opaque blocks that are made of reflective material will be described. When the light collimating device is a parallax barrier plate 56, the material for the opaque block 22b of the parallax barrier plate 56 is not limited and can be made by, for example, metallic material, plastic material, or ink material. Please refer to the FIGS. 12A and 12B. When the opaque block 22b of the parallax barrier plate 56 is formed by the reflective material such as metallic material, the light IR at a large viewing angle shaded by the opaque block 56b can be reflected back into the backlight module 34 and then reflected by the backlight module 34 again towards the direction of the parallax barrier plate for emitting. The light can be recycled and utilized to increase the light emitting efficiency.

According to the design of the above-mentioned various embodiments of the invention, a switchable diffuser can be utilized as the light source control device and disposed between a display panel and the light source provided for the display panel. The light source control device is turned on to be in a first mode and is turned off to be in a second mode. In the first mode, the light being already collimated or separated may pass through the light source control device without changing the original propagation route. In the second mode, the light being already collimated or separated is scattered and changes the original propagation route after passing through the light source control device. Thus, the light source control device can enable an image display device to switch between the two-dimensional (2D) display mode and the three-dimensional (3D) display mode for providing different visual effect. In addition, it may enable an image display device to switch between the narrow viewing angle display mode and the wide viewing angle display mode for displaying the information publicly or privately.

According to the design of the above-mentioned various embodiments of the invention, the image display device is not limited to comprise a parallax optical component or a light collimating device. The image display device can comprise a light path modifying device for changing the light path of the light emitted from the backlight module to generate the first display mode in coordination with the display panel. The parallax optical component or the light collimating device according to the above-mentioned various embodiments of the invention is just one example for the light path modifying device. The light path modifying device, which is used for changing the light path of the light emitted from the backlight module to show a display mode in coordination with the display panel, can be implemented by the existing devices or devises to be developed in the future.

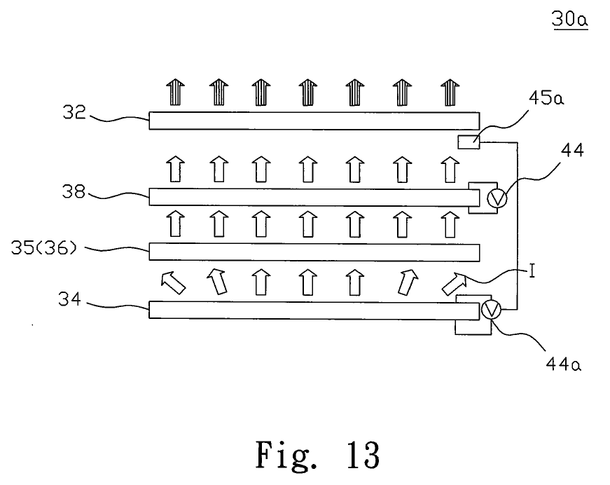

FIG. 13 shows a schematic diagram illustrating the image display device 30a according to another embodiment of the invention. Since the embodiment shown in FIG. 13 is similar to that in FIG. 6, the same symbols are applied to the same devices and the descriptions of the same portion will be omitted so that only the portion that is different between the two embodiments will be described in the followings.

Please refer to FIG. 13. The image display device 30a comprises a display panel 32, a backlight module 34, a light path modifying device 35, a light sensor 45a, and a switchable diffuser 38. In this embodiment, the light path modifying device 35 is a light collimating device 36. Therefore, the image display device 30a can be switched between the wide viewing angle and the narrow viewing angle display modes. In one embodiment, the light path modifying device 35 can also be a parallax optical component. The light sensor 45a is disposed on the light exiting side of the switchable diffuser 38 for performing a brightness measurement of the light passing through the switchable diffuser 38. In this embodiment, the light sensor 45a is disposed on one side of the switchable diffuser 38 facing the display panel 32 and between the display panel 32 and the switchable diffuser 38. In another embodiment, the light sensor 45a can be disposed on the light exiting side of the display panel 32 (not shown in the figure).

Besides, the backlight module 34 shows different brightness modes according to the brightness measurement measured by the light sensor 45a. More specifically, the display brightness of the image display device 30 is reduced when the switchable diffuser 38 switches from the transparent mode to the haze mode and thus the brightness measurement measured by the light sensor 45a also changes from a first level to a second level that is lower than the first level. After receiving the brightness measurement, the backlight module 34 also changes from a first brightness mode to a second brightness mode by sensing the change in the brightness measurement where the brightness of the second brightness mode is higher then the brightness of the first brightness mode. In one embodiment, the image display device 30a can further comprise a second voltage controller 44a coupled to the backlight module 34 and the light sensor 45a. The second voltage controller 44a is for receiving the result of the brightness measurement and providing different voltages to the backlight module 34 according to the brightness measurement. More specifically, the second voltage controller 44a provides a third voltage when the brightness measurement measured by the light sensor 45a is at the first level so that the backlight module 34 shows a first brightness mode after receiving the third voltage. When the brightness measurement measured by the light sensor 45a is at the second level, the second voltage controller 44a provides a fourth voltage so that the backlight module 34 shows a second brightness mode after receiving the fourth voltage. Since the second level is lower than the first level, preferably the fourth voltage is set to be higher than the third voltage.

There are a number of reasons that cause the reduction of the display brightness of the normal direction of the image display device 30. For example, the aging of the backlight module 34 is one of the reasons. Comparing to the embodiment shown in FIG. 6B, the light sensor 45a utilized in this embodiment can sense the display brightness reduction caused by the aging of the backlight module 34 and the voltage provided to the backlight module 34 correspondingly can be increased so that the backlight module 34 can have higher brightness. Therefore, the display brightness shown by the image display device 30a can be more stable and the display quality can be increased.

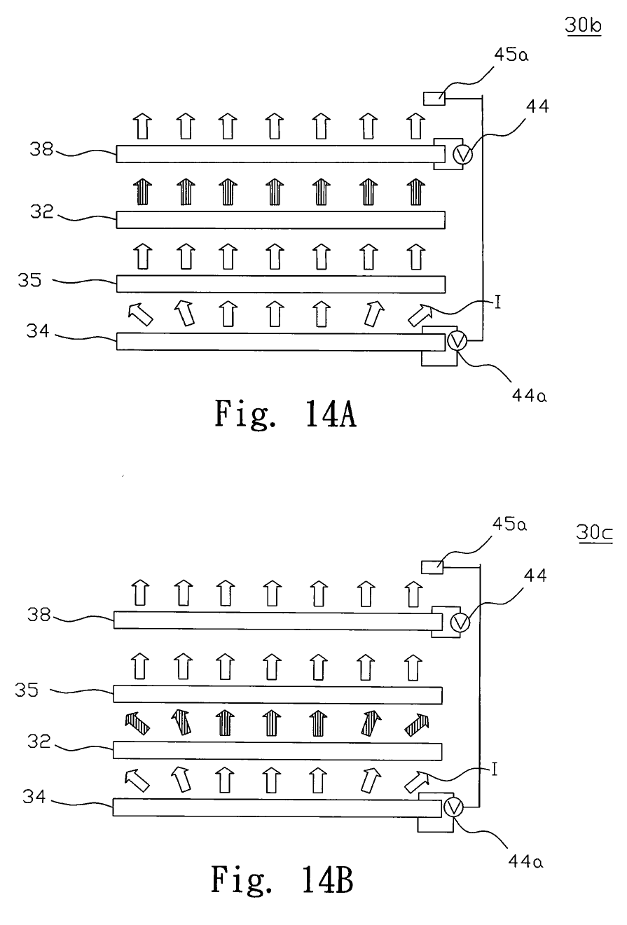

In addition, according to an embodiment of the present invention, the switchable diffuser may not be disposed between the light path modifying device and the display panel for having the function of switching among various display modes. FIGS. 14A and 14B respectively show a schematic diagram illustrating the image display device according to another embodiment of the invention. For convenience in explanation, the components of the embodiment of FIGS. 14A and 14B that are the same as the components of the embodiment of FIG. 13 will be assigned the same component symbols, and the detailed description thereof will not be repeated hereinafter and the difference therebetween is described as follows. As shown in FIG. 14A and FIG. 14B, the display panel 32 and the light path modifying device 35 are disposed between the backlight module 34 and the switchable diffuser 38 in the image display device 30b and 30c. Specifically, the light path modifying device 35 is further disposed between the backlight module 34 and the display panel 32 in the image display device 30b, while the display panel 32 is further disposed between the backlight module 34 and the light path modifying device 35 in the image display device 30c.

On the basis of the design of the image display device 30a, the light passing through the display panel 32 is observed by an observer without passing through the switchable diffuser 38 as the image display device 30b and 30c do not. Accordingly, the image display device 30a, comparing to the image display device 30b and 30c, may display a clearer image and has a better display quality.

Although the preferred embodiments of the present invention has been fully described by way of examples with reference to the accompanying drawings, it should not be construed as any limitation on the implementation range of the invention. Various equivalent changes and modifications can be performed by those who are skilled in the art without deviating from the scope of the invention. The scope of the present invention is to be encompassed by the claims of the present invention. Any embodiment or claim of the present invention does not need to reach all the disclosed objects, advantages, and uniqueness of the invention. Besides, the abstract and the title are only used for assisting the search of the patent documentation and should not be construed as any limitation on the implementation range of the invention.

What is claimed is:

1. An image display device, suitable for displaying a first display mode and a second display mode that is different from the first display mode, the image display device comprising:
a display panel;
a backlight module for emitting light as the display light source of the display panel;
a light path modifying device disposed between the display panel and the backlight module for changing the light path of the light to generate the first display mode in coordination with the display panel;
a switchable diffuser disposed between the light path modifying device and the display panel and being capable of switching between a transparent mode and a scattering mode, wherein the switchable diffuser receiving a first voltage does not scatter the light in the transparent mode, and the switchable diffuser receiving a second voltage scatters the light in the scattering mode,
wherein the display device displays the first display mode in the transparent mode and displays the second display mode in the scattering mode.

2. The image display device according to claim 1, wherein the switchable diffuser is a polymer dispersed liquid crystal (PDLC) panel or a bi-stable cholesteric liquid crystal panel.

3. The image display device according to claim 1, wherein the backlight module optionally displays a first brightness mode or a second brightness mode respectively according to either the transparent mode or the scattering mode displayed by the switchable diffuser.

4. The image display device according to claim 3, wherein the voltage value of one of the first voltage and the second voltage is zero.

5. The image display device according to claim 3, wherein the backlight module receives a third voltage when the switchable diffuser receives the first voltage and the backlight module receives a fourth voltage when the switchable diffuser receives the second voltage.

6. The image display device according to claim 5, further comprising: a first power controller for optionally providing the first voltage or the second voltage and a second power controller for optionally providing the third voltage or the fourth voltage.

7. The image display device according to claim 1, further comprising: a light sensor for sensing the light passing through the switchable diffuser and measuring a brightness measurement of the light wherein the backlight module displays a different brightness mode according to the brightness measurement.

8. The image display device according to claim 7, further comprising: a power controller for providing a different voltage to the backlight module according to the brightness measurement.

9. The image display device according to claim 1, wherein the light path modifying device is a parallax optical component for generating the visual separating effect and the first display mode is the three-dimensional (3D) display mode while the second display mode is the two-dimensional (2D) display mode.

10. The image display device according to claim 9, wherein the parallax optical component is a parallax barrier plate having a plurality of alternately disposed transparent and opaque blocks.

11. The image display device according to claim 10, wherein the opaque block is made of reflective material.

12. The image display device according to claim 10, wherein the opaque block is made by metallic material, plastic material, or ink material.

13. The image display device according to claim 9, wherein the parallax optical component comprises a plurality of focusing lens structures and a plurality of cylindrical lens structures.

14. The image display device according to claim 1, wherein the light path modifying device is a light collimating device for collimating the light emitted from the backlight module and the first display mode shows the narrow viewing angle mode while the second display mode shows the wide viewing angle mode.

15. The image display device according to claim 14, wherein the light collimating device is a parallax barrier plate having a plurality of alternately disposed transparent and opaque blocks.

16. The image display device according to claim 14, wherein the light collimating device comprises a plurality of cylindrical lens structures and a plurality of cylindrical prism structures.

17. A light source control device, suitable for being disposed between a display panel and a light source, being turned on to be in a first mode and being turned off to be in a second mode, wherein the light being already collimated or separated passes through without changing the original propagation route in the first mode and the light being already collimated or separated passes through by changing the original propagation route in the second mode; wherein the first mode corresponds to a three-dimensional (3D) display mode or a narrow viewing angle display mode and the second mode corresponds to a two-dimensional (2D) display mode or a wide viewing angle mode.

18. The light source control device according to claim 17, wherein the light source control device is a polymer dispersed liquid crystal (PDLC) panel or a bi-stable cholesteric liquid crystal panel.

19. The light source control device according to claim 17, wherein the light is separated by a parallax optical component.

20. The light source controlling device according to claim 17, wherein the light is collimated via a cylindrical lens set, a cylindrical prism set, or a light parallax plate.

21. An image display device, suitable for displaying a first display mode and a second display mode that is different from the first display mode, the image display device comprising a display panel, a backlight module, a light path modifying device and a switchable diffuser, wherein
the backlight module is for emitting light as the display light source of the display panel,
the display panel is disposed between the backlight module and the switchable diffuser,
the light path modifying device is disposed between the backlight module and the switchable diffuser for changing the light path of the light to generate the first display mode in coordination with the display panel,
the switchable diffuser is capable of switching between a transparent mode and a scattering mode, wherein the switchable diffuser receiving a first voltage does not scatter the light in the transparent mode, and the switchable diffuser receiving a second voltage scatters the light in the scattering mode, and
the display device displays the first display mode in the transparent mode and displays the second display mode in the scattering mode.
